(19) United States
(12) Patent Application Publication
(10) Pub. No.: US 2017/0264959 A1
(43) Pub. Date: Sep. 14, 2017

(54) IMAGE DISPLAY APPARATUS AND METHOD OF DISPLAYING IMAGE

(71) Applicant: SAMSUNG ELECTRONICS CO., LTD., Suwon-si (KR)

(72) Inventors: Joo-sun MOON, Seoul (KR); Han-sol PARK, Seoul (KR); A-hyeon SHIM, Anyang-si (KR); Young-ah LEE, Seoul (KR); Sung-hyun JANG, Seoul (KR); Sang-hyun JANG, Dalseo-gu (KR)

(21) Appl. No.: 15/435,639

(22) Filed: Feb. 17, 2017

(30) Foreign Application Priority Data
Mar. 11, 2016 (KR) 10-2016-0029680

(51) Int. Cl. H04N 21/472; H04N 21/482

(52) U.S. Cl. CPC H04N 21/472; H04N 21/482

(57) ABSTRACT

An image display apparatus and a method of displaying an image are disclosed. The image display apparatus includes: a display; and a controller configured to display on the display a channel list area including a plurality of channels and an index group area including a plurality of index groups indexing the plurality of channels by grouping the plurality of channels, to dynamically determine the plurality of index groups to be displayed on the index group area based on information regarding the plurality of channels, and to control the display to display the plurality of index groups on the index group area.

### CROSS-REFERENCE TO RELATED APPLICATION

This application is based on and claims priority under 35 U.S.C. §119 to Korean Patent Application No. 10-2016-0029680, filed on Mar. 11, 2016, in the Korean Intellectual Property Office, the disclosure of which is incorporated by reference herein in its entirety.

### BACKGROUND

1. Field

The present disclosure relates generally to an image display apparatus and a method of displaying an image, and for example, to a method of displaying multiple channels.

2. Description of Related Art

An image display apparatus has a function of displaying an image that a user may view. The user may watch broadcasts through the image display apparatus. An image display apparatus displays, on a screen, a broadcast selected by a user from among broadcast signals transmitted from broadcast stations. Currently, broadcasting has been converted from analog broadcasting into digital broadcasting all over the world.

In digital broadcasting, digital images and voice signals may be transmitted. In comparison with analog broadcasting, little data is lost in digital broadcasting as it has excellent characteristics in terms of high resistance to external noise, robust error correction, high resolution, and provision of a clear screen. In addition, digital broadcasting provides a bidirectional service unlike in the case of analog broadcasting.

Also, smart televisions (TVs) that provide various types of content in addition to a digital broadcasting function have been recently supplied. A smart TV does not manually operate according to a user selection, but analyzes and provides what a user wants without manipulation by the user.

### SUMMARY

Various example aspects will be set forth in part in the description which follows and, in part, will be apparent from the description.

According to an aspect of an example embodiment, an image display apparatus includes: a display; and a controller configured to display a channel list area including a plurality of channels and an index group area including a plurality of index groups for indexing the plurality of channels by grouping the plurality of channels, to dynamically determine the plurality of index groups to be displayed on the index group area based on information regarding the plurality of channels, and to control the display to display the plurality of index groups on the index group area.

In response to a user input selecting one of the plurality of index groups displayed on the index group area, the controller may be further configured to move a highlight to the selected index group and display at least one channel corresponding to the selected index group on the channel list area.

The controller may be further configured to differently set a number of channels corresponding to each of the plurality of index groups, based on a total number of channels displayed on the channel list area.

The controller may be further configured to change a number of index groups to which the highlight moves at a time on the index group area.

The controller may be further configured to set a name of each of the plurality of index groups based on channel arrangement criteria on the channel list area.

When the plurality of channels are arranged on the channel list area based on channel numbers, the controller may be further configured to set a name of each of the plurality of index groups using the channel numbers.

When the plurality of channels are arranged on the channel list area based on channel names, the controller may be further configured to set a name of each of the plurality of index groups using a character.

The display may be configured to display, on an upper portion of the index group area, an index group including one or more favorite channels of a user.

According to an aspect of another example embodiment, a method of displaying an image, includes: displaying a channel list area including a plurality of channels and an index group area including a plurality of index groups for indexing the plurality of channels by grouping the plurality of channels; dynamically determining the plurality of index groups to be displayed on the index group area based on information regarding the plurality of channels; and displaying the plurality of index groups on the index group area.

The method may further include: moving a highlight to the selected index group based on a received input selecting one of the plurality of index groups displayed on the index group area; and displaying at least one channel corresponding to the selected index group on the channel list area.

The flexible determining of the plurality of index groups may include differently setting a number of channels corresponding to each of the plurality of index groups, based on a total number of channels displayed on the channel list area.

The moving of the highlight may include changing a number of index groups to which the highlight moves at a time, based on the user input.

The dynamic determining of the plurality of index groups may include setting a name of each of the plurality of index groups based on channel arrangement criteria on the channel list area.

The dynamic determining of the plurality of index groups may include, when the plurality of channels are arranged on the channel list area based on channel numbers, setting a name of each of the plurality of index groups using the channel numbers.

The dynamic determining of the plurality of index groups may include, when the plurality of channels are arranged on the channel list area based on channel names, setting a name of each of the plurality of index groups using a character.

The displaying of the plurality of index groups may include displaying, on an upper portion of the index group area, an index group including one or more favorite channels of a user.

### BRIEF DESCRIPTION OF THE DRAWINGS

These and/or other aspects and features of the present disclosure will become apparent and more readily appreciated from the following detailed description, taken in conjunction with the accompanying drawings, in which like reference numerals refer to like elements, and wherein:

FIG. 1 is a diagram illustrating an example image display apparatus for performing a method of displaying an image, according to an example embodiment;

FIG. 2 is a flowchart illustrating an example method of displaying an image, according to an example embodiment;

FIG. 3 is a diagram illustrating an example of arranging channels on an image display apparatus based on channel numbers, according to an example embodiment;

FIGS. 4A, 4B and 4C are diagrams illustrating examples of flexibly or dynamically determining index groups on an image display apparatus, according to an example embodiment;

FIGS. 5A, 5B and 5C are diagrams illustrating examples of flexibly or dynamically determining index groups, according to an example embodiment;

FIG. 6 is a diagram illustrating an example of setting names of index groups on an image display apparatus, according to an example embodiment;

FIGS. 7A and 7B are diagrams illustrating examples of changing channel arrangement criteria on an image display apparatus, according to an example embodiment;

FIGS. 8A and 8B are diagrams illustrating examples of setting names of index groups on an image display apparatus, according to an example embodiment;

FIG. 9 is a diagram illustrating example movement of a highlight from an index group area to a channel list area on an image display apparatus, according to an example embodiment;

FIGS. 10A and 10B are diagrams illustrating an example index group including favorite channels of a user on an image display apparatus, according to an example embodiment;

FIG. 11 is a block diagram illustrating an example structure of an image display apparatus according to an example embodiment; and

FIG. 12 is a block diagram illustrating an example structure of an image display apparatus according to another example embodiment.

### DETAILED DESCRIPTION

The present disclosure will now be described more fully with reference to the accompanying drawings, in which various example embodiments of the present disclosure are shown. The present disclosure may, however, be embodied in many different forms and should not be construed as being limited to the embodiments set forth herein; rather, these embodiments are provided so that this present disclosure will be thorough and complete, and will fully convey the concept of the present disclosure to those of ordinary skill in the art. In the drawings, portions that are not relevant to the descriptions of the present disclosure may be omitted, and like reference numerals denote like elements.

The terms used in this disclosure are those general terms currently widely used in the art in consideration of functions regarding the present disclosure, but the terms may vary according to the intention of those of ordinary skill in the art, precedents, or new technology in the art. Also, specified terms may be arbitrarily selected, and in this case, the detailed meaning thereof will be described in the detailed description of the present disclosure. Thus, the terms used in the specification should be understood not as simple names but based on the meaning of the terms and the overall description of the present disclosure.

The terms used in the present specification are merely used to describe various example embodiments, and are not intended to limit the present disclosure. An expression used in the singular encompasses the expression of the plural, unless it has a clearly different meaning in the context. It will be understood that when a component, such as a layer, a film, a region, or a plate, is referred to as being “connected to” another component, the component can be “directly connected to” the other component or “electrically connected to” the other component with an intervening component therebetween. Also, throughout the specification, when a portion “includes” an element, another element may be further included, rather than excluding the existence of the other element, unless otherwise described.

The use of the terms “a” and “an” and “the” and similar referents in the context of describing the present disclosure are to be construed to cover both the singular and the plural. Also, the steps of all methods described herein can be performed in any suitable order unless otherwise indicated herein or otherwise clearly contradicted by context. The present disclosure is not limited to the described order of the steps.

The expressions such as “in some embodiments” and “in one embodiment” do not necessarily indicate the same embodiment.

The present disclosure may be described in terms of functional block components and various processing steps. Such functional blocks may be realized by any number of hardware and/or software components configured to perform the specified functions. For example, the functional blocks may be realized by at least one or more microprocessor or circuit components configured to perform certain functions. Also, for example, the functional blocks may be implemented with any programming or scripting language. Functional blocks may be implemented in algorithms that are executed on one or more processors. Furthermore, the present disclosure could employ any number of conventional techniques for electronics configuration, signal processing and/or control, data processing and the like. The words “mechanism”, “element”, “means”, and “configuration” are used broadly and are not limited to mechanical or physical embodiments.

Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device.

Hereinafter, the present disclosure will be described in greater detail with reference to the attached drawings.

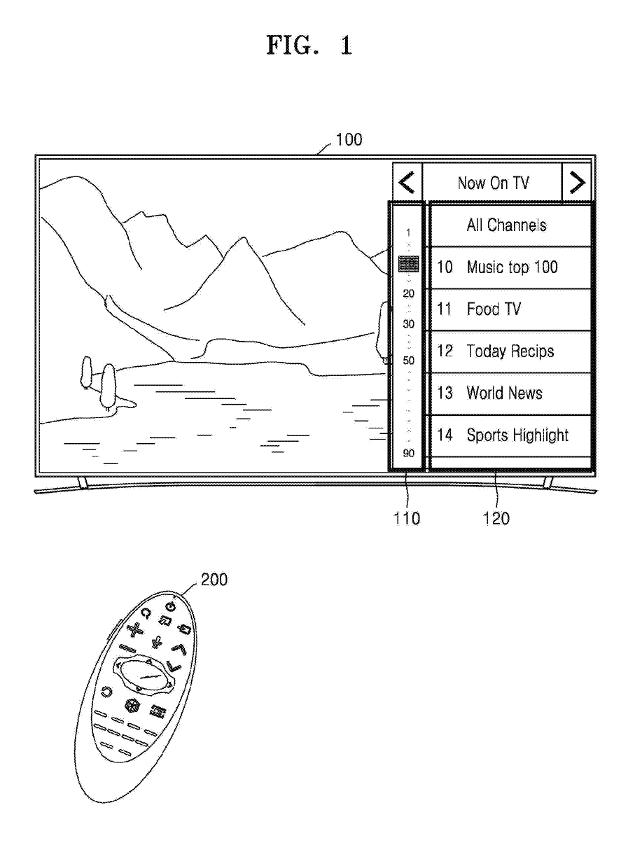

FIG. 1 is a diagram illustrating an example image display apparatus 100 for performing a method of displaying an image, according to an example embodiment.

As illustrated in FIG. 1, the image display apparatus 100 may be a television (TV), but is not limited thereto. The image display apparatus 100 may be an electronic apparatus including a display. For example, the image display apparatus 100 may be realized as an electronic apparatus such as a mobile phone, a tablet personal computer (PC), a digital camera, a camcorder, a laptop computer, a desktop computer, an e-book reader, a digital broadcasting terminal, a personal digital assistant (PDA), a portable multimedia player (PMP), a navigation device, an MP3 player, or a wearable device, or the like, but is not limited thereto. In addition, the image display apparatus 100 may be of a fixed type or a portable type and may be a digital broadcasting receiver that may receive a digital broadcast.

The image display apparatus 100 may be realized as a flat image display apparatus, a curved image display apparatus having curvature, or a flexible image display apparatus having adjustable curvature. A resolution of the image display apparatus 100 may be, for example, high definition (HD), full HD, ultra HD, or a resolution greater than ultra HD.

A control device 200 may be realized as a device, for example, a remote control or a mobile phone, which controls the image display apparatus 100.

When a display of the image display apparatus 100 is a touch screen, the control device 200 may be replaced with a finger of a user, an input pen, or the like.

The control device 200 may control the image display apparatus 100 through short-distance communication including infrared communication or Bluetooth. The control device 200 may control functions of the image display apparatus 100 by using at least one of a key (including a button), a touchpad, a microphone (not shown) capable of receiving voices of the user, and a sensor (not shown) capable of detecting motions of the control device 200.

The control device 200 may include on/off buttons for turning on/off the image display apparatus 100. The control device 200 may change channels, adjust the volume, select a terrestrial broadcast/cable broadcast/satellite broadcast, or perform an environment setting of the image display apparatus 100 based on received user inputs.

The control device 200 may be a pointing device. For example, the control device 200 may operate as a pointing device when a certain key input is received.

In one or more embodiments of the present disclosure, the term “user” denotes a person who controls functions or operations of the image display apparatus 100 by using the control device 200 and may include a viewer, an administrator, or an installation engineer.

As types of content are diversified, the image display apparatus 100 may provide content through channels and may display a channel list including the channels on a screen. In addition, due to an increasing number of channels, it may not be easy for the user to search for a desired channel from the channel list displayed on the screen. Thus, a method of helping the user easily search for a desired channel from among channels may be required.

The image display apparatus 100 performs a method of distinguishing index groups for indexing channels by grouping the channels from the channel list and displaying the index groups. FIG. 1 illustrates examples of an index group area 110 and a channel list area 120 which will be described in greater detail below with reference to various figures and examples. Accordingly, the image display apparatus 100 may help the user easily search for a desired channel from among a variety of channels.

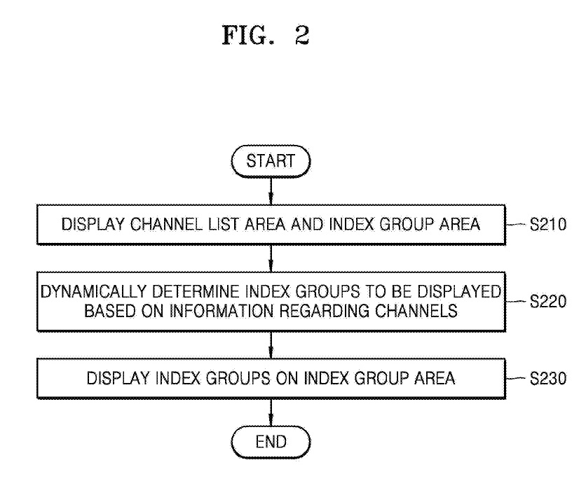

FIG. 2 is a flowchart illustrating an example method of displaying an image, according to an example embodiment.

In operation S210, the image display apparatus 100 displays a channel list area 120 and an index group area 110. The channel list area includes channels and the index group area includes index groups for indexing channels by grouping the channels.

The image display apparatus 100 according to an embodiment may display, on the channel list area 120, the channels provided by the image display apparatus 100 according to preset criteria. For example, the channels may be arranged according to channel numbers, channel names, and categories (e.g., movies, TV dramas, sports, etc.) of content on the channels, and the arranged channels may be displayed on the channel list area. However, the present disclosure is not limited thereto.

The image display apparatus 100 according to an embodiment may display the index groups 110 for grouping and indexing channels the channels so as to help the user easily search for a channel. In this case, the index groups may indicate that the channels are grouped according to certain criteria. For example, the image display apparatus 100 may set channels having the same type of content as an index group or channels having the same first letter in their names as an index group. Alternatively, the image display apparatus 100 may set a preset number of channels having adjacent channel numbers as one index group. Since the number of index groups is relatively smaller than the number of channels, the image display apparatus 100 may display all of the index groups on one screen and thus may quickly search for the channels.

The image display apparatus 100 according to an embodiment may adjust transparency of the index group area 110 and the channel list area 120 and may display the index group area and the channel list area having the adjusted transparency. For example, the image display apparatus 100 may display the index group area and the channel list area translucently, and thus, the user may keep watching content being displayed on the screen, while searching for another channel. The image display apparatus 100 may set the transparency of the index group area and the channel list area according to user convenience.

In operation S220, the image display apparatus 100 may flexibly (e.g., dynamically) determine the index groups to be displayed on the index group area, based on information regarding the channels. The information regarding the channels may indicate the total number of channels. For example, when there are 100 channels in total, the image display apparatus 100 may set 10 channels as one index group. On the other hand, when there are 1000 channels in total, the image display apparatus 100 may set 100 channels as one index group. Accordingly, the user may quickly search for a channel that he/she wants.

The image display apparatus 100 may differently set index groups according to change arrangement criteria. For example, when the channels are arranged based on channel numbers, the image display apparatus 100 may set a preset number of channels having adjacent channel numbers as one index group. Alternatively, when the channels are arranged based on channel names, the image display apparatus 100 may set channels having the same first letter in their names (e.g., the first letter of the alphabet in an English name, an initial consonant in a Korean syllable, etc.) as one index group. A method of setting an index group will be described later in detail.

In operation S230, the image display apparatus 100 may display the determined index groups on the index group area.

The image display apparatus 100 may distinguish the index group area 110 including the index groups from the channel list area 120 when the index group area and the channel list area are displayed. For example, when there are 100 channels in total and 10 channels are set as one index group, the image display apparatus 100 may set all of the channels as 10 index groups. It may be easier to display 10 index groups on one screen than displaying 100 channels on the screen. In addition, the user may select an index group including a desired channel from among the index groups displayed on the index group area and may search for the desired channel in the selected index group.

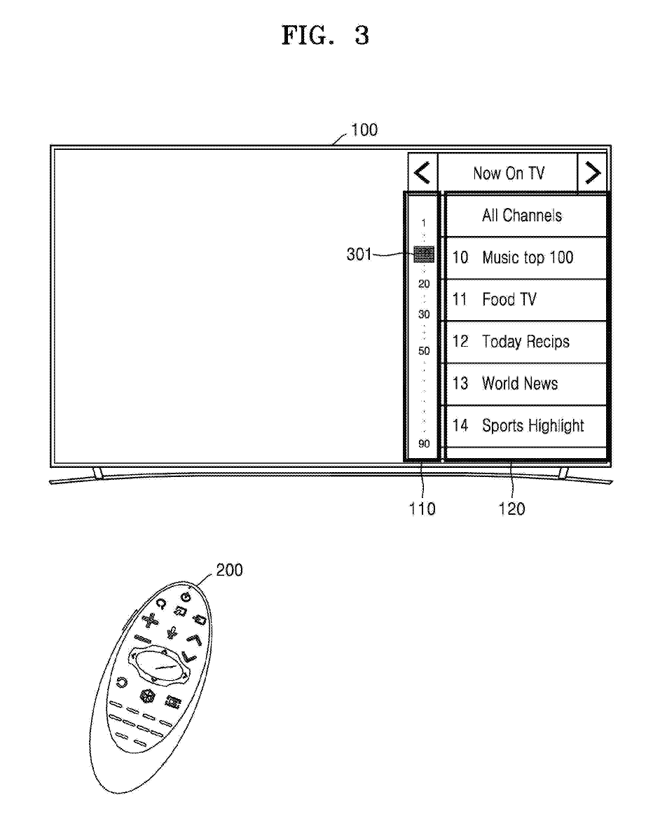

Hereinafter, an example method of displaying an image will be described in greater detail below with reference to FIGS. 3 to 10.

As described above, the index group area 110 may differ based on the channel arrangement criteria (e.g., channel numbers, channel names, content categories, etc.).

FIG. 3 is a diagram illustrating an example of arranging the channels on the image display apparatus 100 based on the channel numbers, according to an example embodiment.

As illustrated in FIG. 3, when the channels are arranged on a channel list area 120 based on the channel numbers, each index group may include a preset number of channels having adjacent channel numbers. For example, when there are 100 channels in total, the image display apparatus 100 may set each index group to include 10 channels having adjacent channel numbers. In this case, an index group 10 301 may include channels 10 to 19, and an index group 20 may include channels 20 to 29.

In response to a user input for selecting one of the index groups, the image display apparatus 100 according to an embodiment may display, on the channel list area 120, one or more channels corresponding to the selected index group. For example, as illustrated in FIG. 3, the image display apparatus 100 may display the channels 10 to 19 which correspond to the index group 10 301 in response to a user input for selecting the index group 10 301.

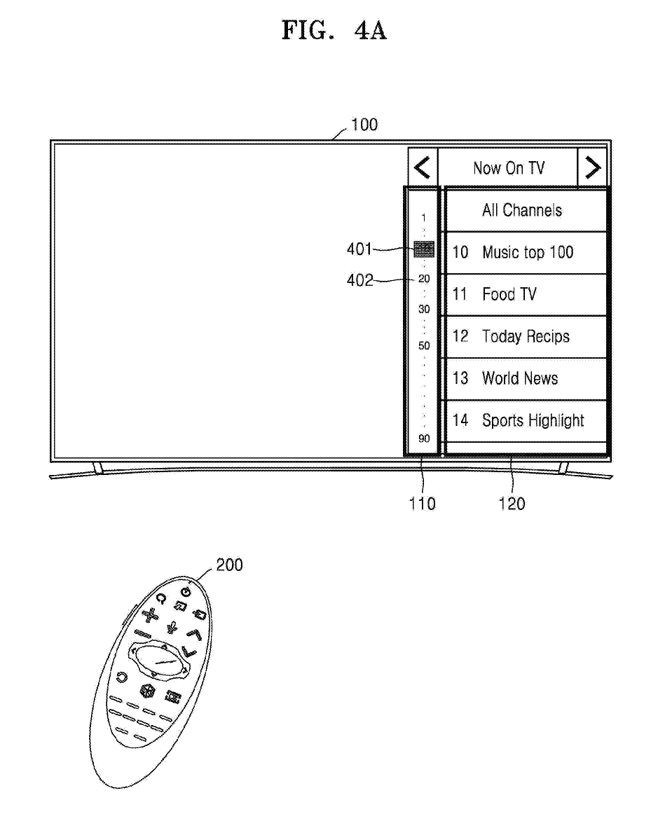

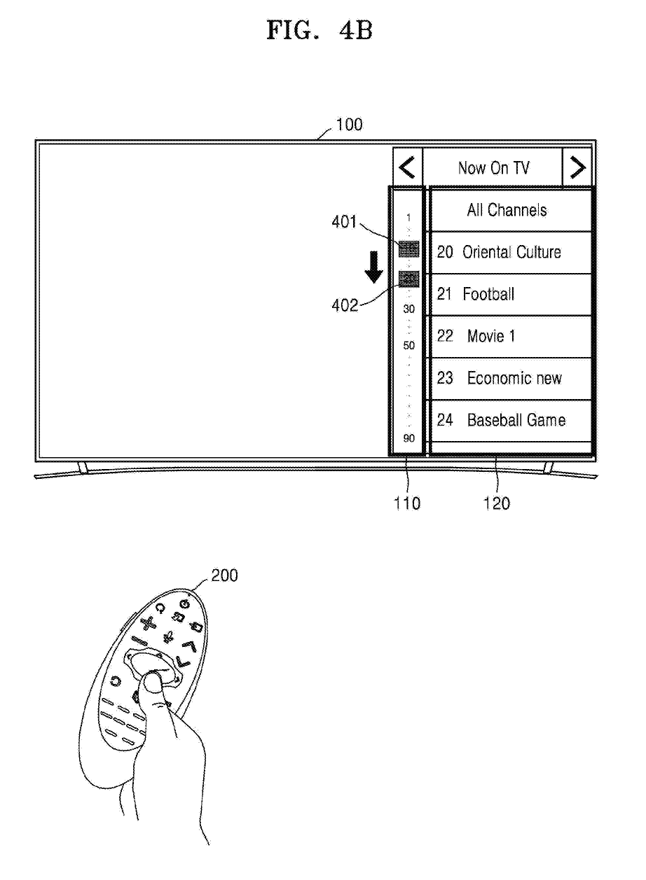

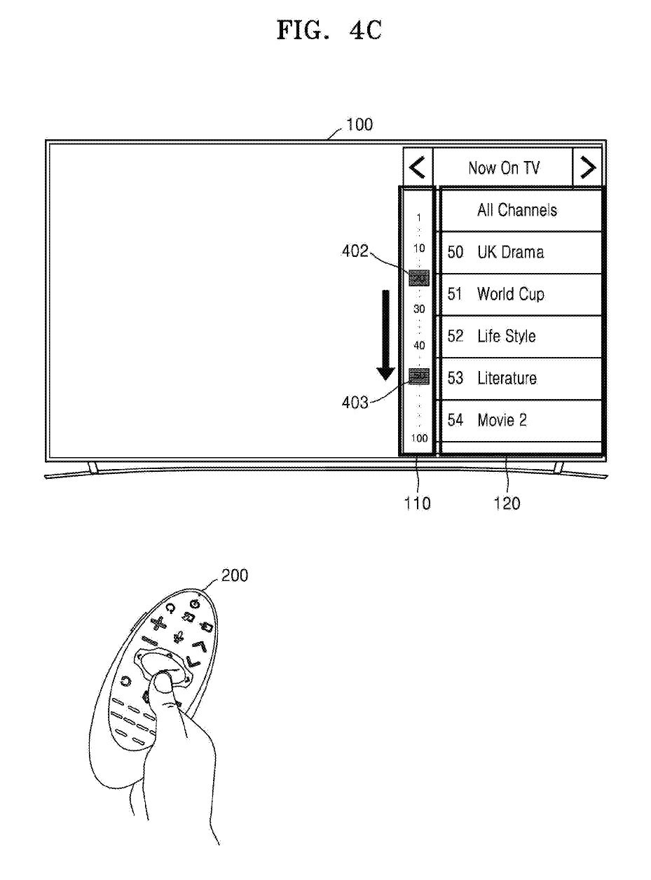

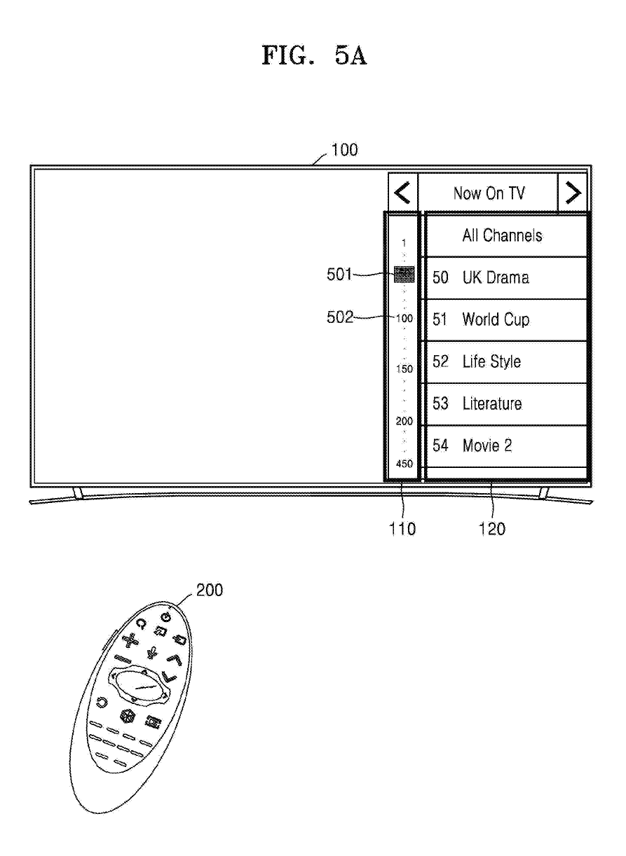

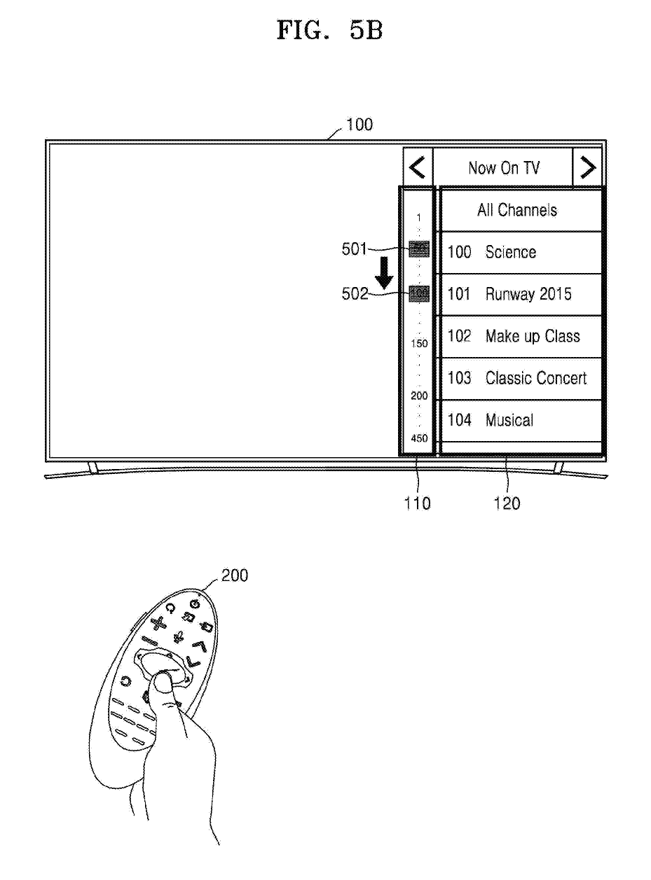

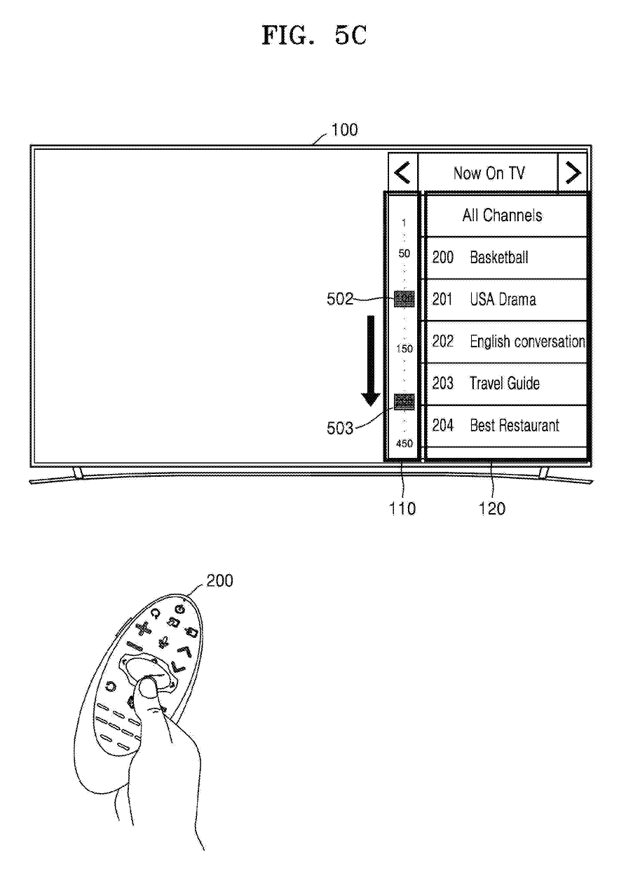

FIGS. 4A, 4B, 4C, 5A, 5B and 5C are diagrams illustrating examples of flexibly (e.g., dynamically) determining the index groups on the image display apparatus 100, according to an example embodiment.

The image display apparatus 100 may flexibly (e.g., dynamically) determine the index groups according to the total number of channels. When the number of channels included in each index group is identical regardless of the total number of channels, the total number of channels increase, and thus the number of index groups may also increase. When the number of index groups increases, the image display apparatus 100 may not display all of the index groups on the index group area 110. Accordingly, the image display apparatus 100 may flexibly determine the index groups based on the total number of channels and thus may easily display the index groups on the index group area 110.

FIGS. 4A, 4B and 4C illustrate examples in which the total number of channels is 100.

Referring to FIG. 4A, the image display apparatus 100 may set 100 channels as 10 index groups (e.g., index groups 10 to 90), and each index group may include 10 channels. For example, an index group 10 401 may include channels 10 to 19, and an index group 20 402 may include channels 20 to 29. The image display apparatus 100 may display all of the index groups on the index group area 110.

In response to a user input for selecting one of the index groups, the image display apparatus 100 may place a highlight on the selected index group. For example, as shown in FIG. 4A, when the index group 10 401 is selected from among index groups 1 to 90, the image display apparatus 100 may place a highlight on the index group 10 401. In this case, the highlight may include all methods of distinguishing a selected index group from other index groups. For example, as shown in FIG. 4A, the image display apparatus 100 may indicate the selected index group, that is, the index group 10 401, with a different color so as to distinguish the selected index group from other index groups. As another example, the image display apparatus 100 may highlight a name of the selected index group in bold, compared to names of the other index groups. However, the present disclosure is not limited thereto.

The image display apparatus 100 may display, on the channel list area 120, one or more channels corresponding to the selected index group.

For example, when the index group 10 401 is selected, the image display apparatus 100 may display the channels 10 to 19 corresponding to the index group 10 401 on the channel list area 120. In this case, the image display apparatus 100 may not easily display 10 channels corresponding to one index group all at once on the channel list area 120. Thus, as illustrated in FIG. 4A, the image display apparatus 100 may display some channels (e.g., the channels 10 to 14) among the channels 10 to 19 corresponding to the index group 10 401.

Also, the image display apparatus 100 may display the rest (e.g., the channels 15 to 19) of the channels 10 to 19 on the channel list area 120 in response to a user input for scrolling on the channel list area 120. In this case, the user input may include a scrolling operation as well as an operation of selecting a certain arrow key. However, the present disclosure is not limited thereto.

The image display apparatus 100 may move the highlight to the selected index group in response to a user input for moving the highlight on the index group area 110. Then, the image display apparatus 100 may display one or more channels corresponding to a newly selected index group on the channel list area 120.

For example, as illustrated in FIG. 4B, in response to a user input for selecting a down arrow key on the control device 200, the image display apparatus 100 may move the highlight to a newly selected index group, that is, the index group 20 402. The image display apparatus 100 may display channels 20 to 29 corresponding to the index group 20 402 on the channel list area 120.

The image display apparatus 100 may change the number of index groups to which the highlight may move at a time on the index group area 110, according to a user input.

For example, referring to FIG. 4C, in response to a user input for pressing the down arrow key for a relatively long time, the image display apparatus 100 may move the highlight from the index group 20 402 to an index group 50 403 at a time. The term “user input” used herein may indicate an input for pressing a certain arrow key for a relatively long time on, for example, the control device 200 including a touch pad. However, the present disclosure is not limited thereto. Also, FIG. 4C illustrates that the highlight moves through three index groups at a time, but the number of index groups through which the highlight moves at a time may differ according to the total number of channels and the total number of index groups. For example, when there are 300 channels and 15 index groups in total, the image display apparatus 100 may set the highlight to move through 5 index groups at a time in response to the user input for pressing a certain arrow key for a relatively long time.

FIGS. 5A, 5B and 5C illustrate an example in which the total number of channels is 500.

Referring to FIG. 5A, the image display apparatus 100 may set 500 channels as 10 index groups (e.g., index groups 1, 50, 100, . . . , 450). In this case, unlike the cases shown in FIGS. 4A to 4C, one index group may include 50 channels. For example, as shown in FIG. 5A, an index group 50 501 may include channels 50 to 99, and an index group 100 502 may include channels 100 to 149. However, although the total number of channels is 500, the number of index groups and the number of channels included in one index group may differ according to a setting. However, the present disclosure is not limited thereto.

As illustrated in FIG. 5A, the image display apparatus 100 may place a highlight on the index group 50 501 in response to a user input for selecting the index group 50 501 from among the 10 index groups on the control device 200.

The image display apparatus 100 may display the channels 50 to 99 corresponding to the index group 50 501 on the channel list area 120. As the number of channels corresponding to one index group increases, it may not be easy to display the channels corresponding to the selected index group all at once on the channel list area 120. Accordingly, as illustrated in FIG. 5A, the image display apparatus 100 may display some channels (e.g., the channels 50 to 54) among the channels 50 to 99 corresponding to the index group 50 501. Then, in response to a user input for scrolling on the channel list area 120, the image display apparatus 100 may display the rest of the channels (e.g., the channels 55 to 90) on the channel list area 120. In this case, the user input may include the scrolling operation as well as the operation of selecting a certain arrow key. However, the present disclosure is not limited thereto.

Referring to FIG. 5B, in response to a user input for moving the highlight from the index group 50 501 to the index group 100 502, the image display apparatus 100 may move the highlight to a newly selected index group, that is, the index group 100 502. The image display apparatus 100 may display channels 100 to 149 corresponding to the index group 100 502 on the channel list area 120.

As described above, the image display apparatus 100 may change the number of index groups through which the highlight moves at a time on the index group area 110, according to a user input. For example, as illustrated in FIG. 5C, the image display apparatus 100 may move the highlight immediately from the index group 100 502 to an index group 200 503 in response to a user input for pressing a down arrow key for a relatively long time.

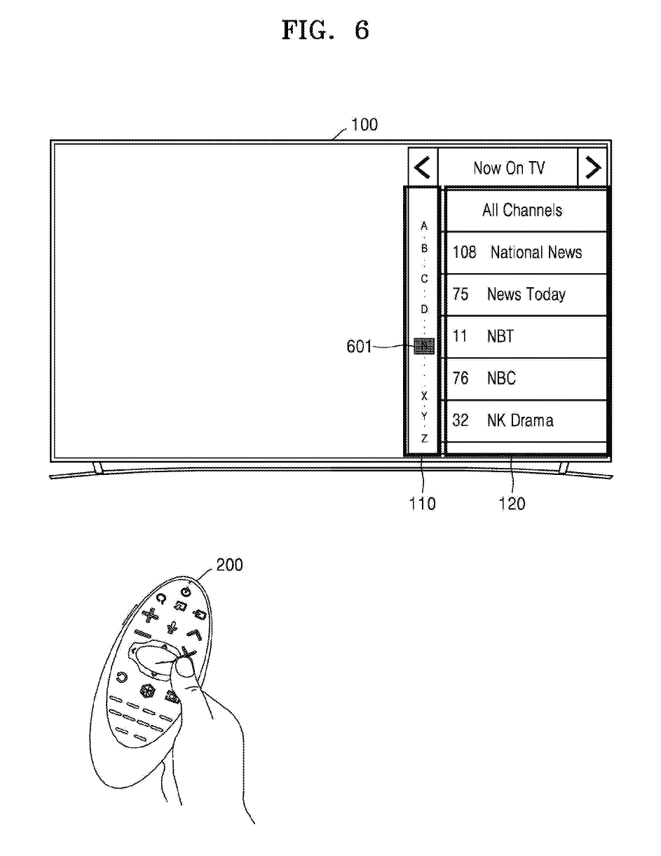

FIG. 6 is a diagram illustrating an example of arranging the channels on the image display apparatus 100 based on channel names, according to an example embodiment.

As illustrated in FIG. 6, the channels may be arranged on the channel list area 120 based on the channel names. In this case, each index group may include channels having the same first letter in their names (e.g., the first letter of the alphabet in an English name, an initial consonant in a Korean syllable, etc.). For example, as illustrated in FIG. 6, an index group N 601 may include channels having names starting from the alphabet ‘N’. When the index group N 601 is selected, the image display apparatus 100 may display channels (e.g., a channel 108 (National News), a channel 75 (News Today), a channel 11 (NBT), a channel 76 (NBC), and a channel 32 (NK Drama)) corresponding to the index group N 601 on the channel list area 120.

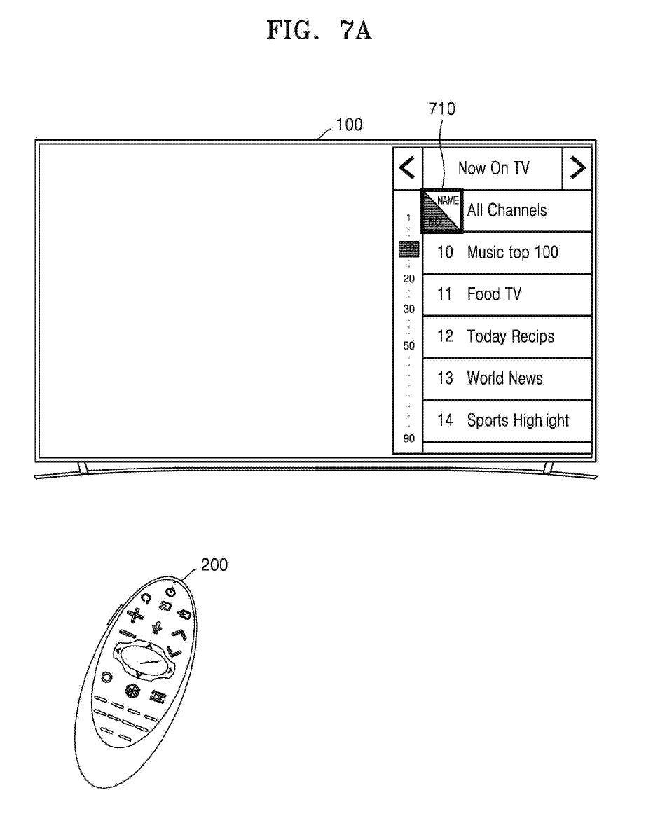

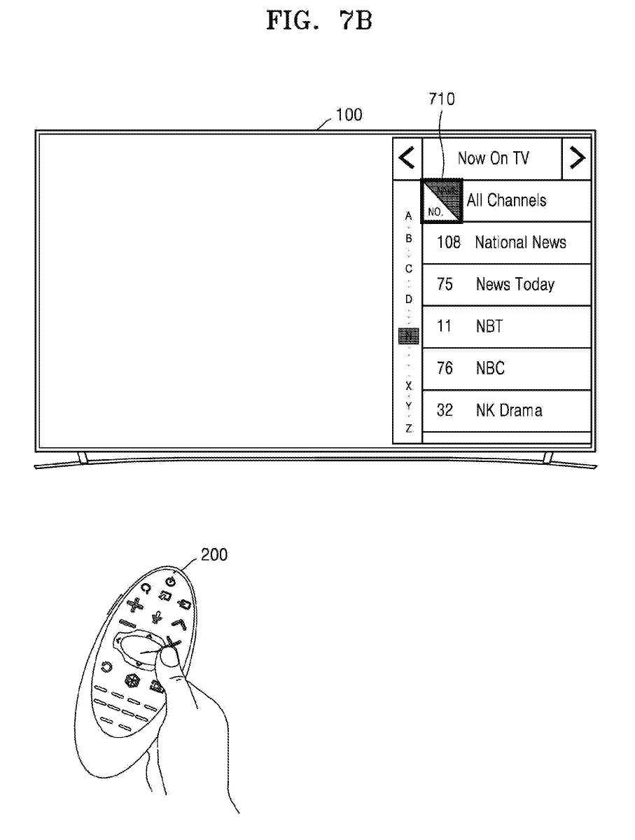

FIGS. 7A and 7B are diagrams illustrating examples of changing channel arrangement criteria on the image display apparatus 100 according to user settings, according to an example embodiment.

Referring to FIG. 7A, the image display apparatus 100 may display a menu 710 used to change the channel arrangement criteria according to a user setting. In this case, the menu 710 may be displayed in a text form as illustrated in FIG. 7A or may be displayed as icons or a drop-down menu. However, the present disclosure is not limited thereto. Also, as illustrated in FIG. 7A, the menu 710 may be fixed at a certain location or may be displayed on a pop-up window according to the use setting.

For example, as illustrated in FIG. 7A, when “No.” is selected on the menu 710, the channels may be arranged on the channel list area 120 based on the channel numbers. As illustrated in FIG. 3, the image display apparatus 100 may set a preset number of channels having adjacent channel numbers as one index group. For example, as illustrated in FIGS. 4A to 4C, when there are 100 channels in total, the image display apparatus 100 may set one index group to include 10 channels. Alternatively, as illustrated in FIGS. 5A to 5C, when there are 500 channels in total, the image display apparatus 100 may set one index group to include 50 channels. However, the number of channels included in an index group may differ according to settings, and the present disclosure is not limited thereto.

Also, the image display apparatus 100 may change an order of arranging the channels displayed on the channel list area 120 and a method of setting the index groups displayed on the index group area 110 in response to a user input for changing the channel arrangement criteria. For example, as shown in FIG. 7B, the image display apparatus 100 may arrange the channels displayed on the channel list area 120, in response to the user input for changing the channel arrangement criteria from the channel number setting “No.” to the “Name” setting. As described above with reference to FIG. 6, each index group may include the channels having the same first letter in their names (e.g., the first letter of the alphabet in an English name, an initial consonant in a Korean syllable, etc.). In this case, as illustrated in FIG. 7B, the user input for changing the channel arrangement criteria from “No.” to “Name” may be the input for selecting the certain arrow key. However, the present disclosure is not limited thereto.

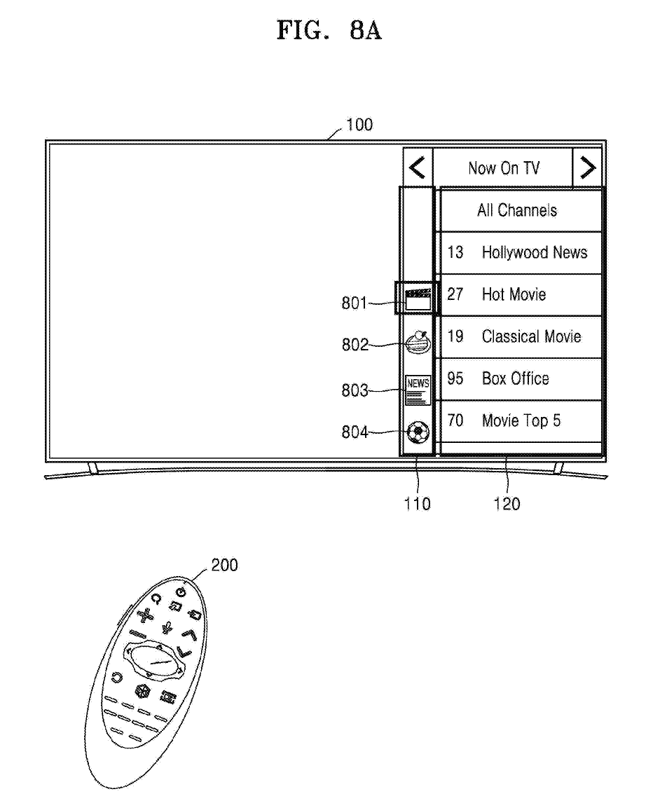

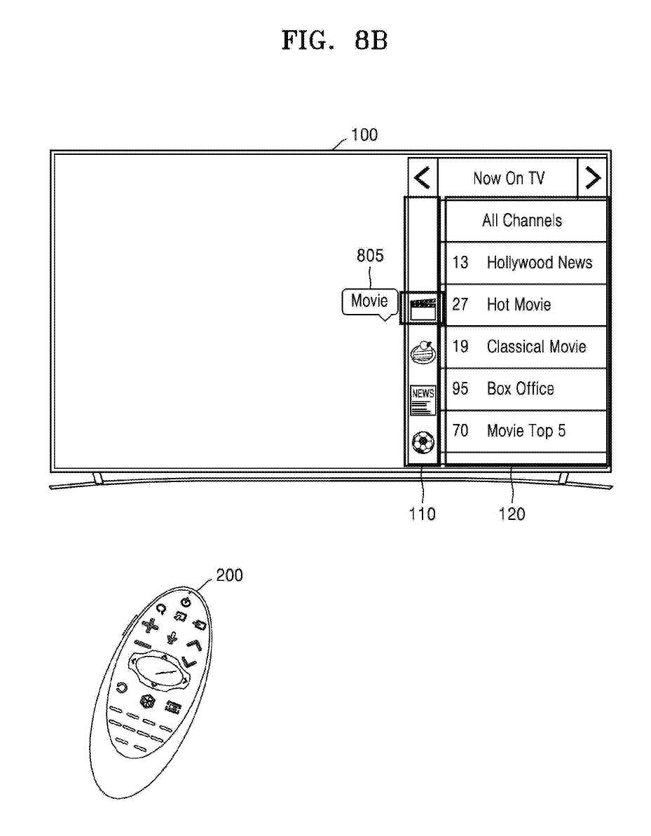

FIGS. 8A and 8B are diagrams illustrating examples of arranging the channels on the image display apparatus 100 according to types of content, according to an example embodiment.

The image display apparatus 100 may arrange the channels on the channel list area 120 based on categories (e.g., movies, TV dramas, sports, news, documentaries, education, etc.) of content provided by each channel. The image display apparatus 100 may set channels in the same category as one index group. For example, as illustrated in FIG. 8A, the image display apparatus 100 may set channels providing movie-related content (e.g., a channel 13 (Hollywood Movie), a channel 27 (Hot Movie), a channel 19 (Classical Movie), a channel 95 (Box Office), a channel (Movie Top 5)) as one index group.

As illustrated in FIG. 8A, the image display apparatus 100 may display the index groups, which are set based on the categories of the content, as icons 801 to 804 on the index group area 110. For example, an index group indicated by the icon 801 may include the channels providing the movie-related content, and an index group indicated by the icon 802 may include channels providing content regarding cooking, foods, or famous restaurants. Also, an index group indicated by the icon 803 may include channels providing news-related content, and an index group indicated by the icon 804 may include channels providing sports-related content. However, the icons 801 to 804 illustrated in FIG. 8A are merely examples, and the categories of the content, an icon indicating a category of certain content, and index groups that are set according to the categories of the content may differ according to embodiments.

When the index groups are displayed as icons, the image display apparatus 100 may display a category of content regarding a selected index group as a text in response to a user input for selecting a certain index group. For example, when the index group including the channels providing the movie-related content is selected, the image display apparatus 100 may display the word “MOVIE” in a text form. Accordingly, the image display apparatus 100 may allow the user to easily check the index group displayed as an icon. In this case, as illustrated in FIG. 8B, the image display apparatus 100 may display the word “MOVIE” on a speech balloon 805. However, the present disclosure is not limited thereto.

Also, according to an embodiment, the image display apparatus 100 may display the index groups that are set based on the categories of the content as texts instead of the icons. In this case, when a length of a text indicating the category of the content is too long to be displayed on the index group area 110, the image display apparatus 100 may display part of the text. When a certain index group is selected, the image display apparatus 100 may allow the text to scroll horizontally such that the entire text may be displayed. For example, when the certain index group includes channels regarding “documentaries”, the image display apparatus 100 may display “DOCU” on the index group area 110. When the index group including the channels regarding documentaries is selected, the image display apparatus 100 may allow the word “DOCUMENTARY” to scroll horizontally such that the user may check the entire text. However, the method of displaying the category of the content in a text form is not limited to the above examples.

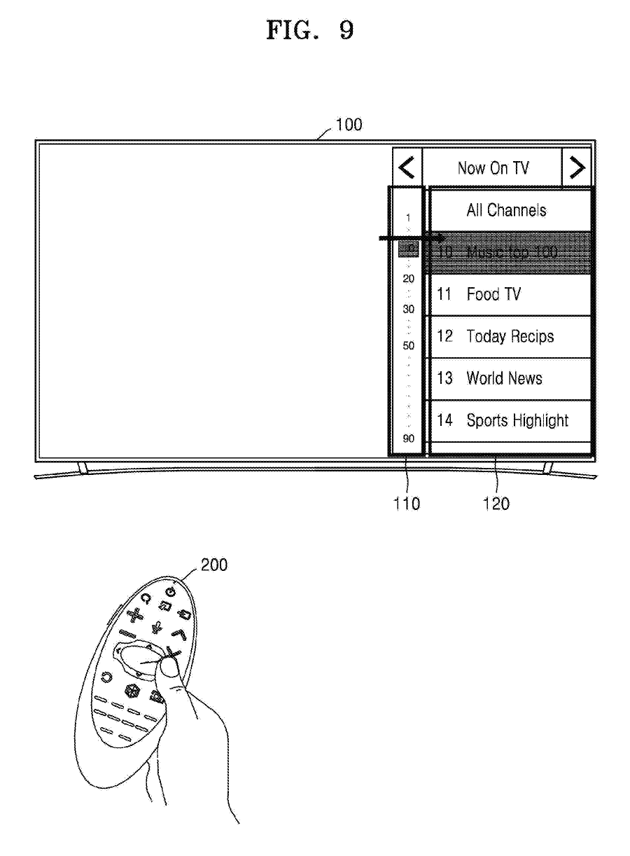

FIG. 9 is a diagram illustrating example movement of a highlight on the image display apparatus 100 based on a user input, according to an example embodiment.

The image display apparatus 100 may select a certain index group by moving the highlight on the index group area 110 and may move the highlight to the channel list area 120 in order to search for a certain channel of the selected index group. Alternatively, the image display apparatus 100 may move the highlight on the channel list area 120 and then may move the highlight to the index group area 110 in order to change the selected index group.

For example, as illustrated in FIG. 9, the image display apparatus 100 may move the highlight from the index group area 110 to the channel list area 120 in response to a user input for selecting a right arrow key. Alternatively, the image display apparatus 100 may move the highlight from the channel list area 120 to the index group area 110 in response to a user input for selecting a left arrow key.

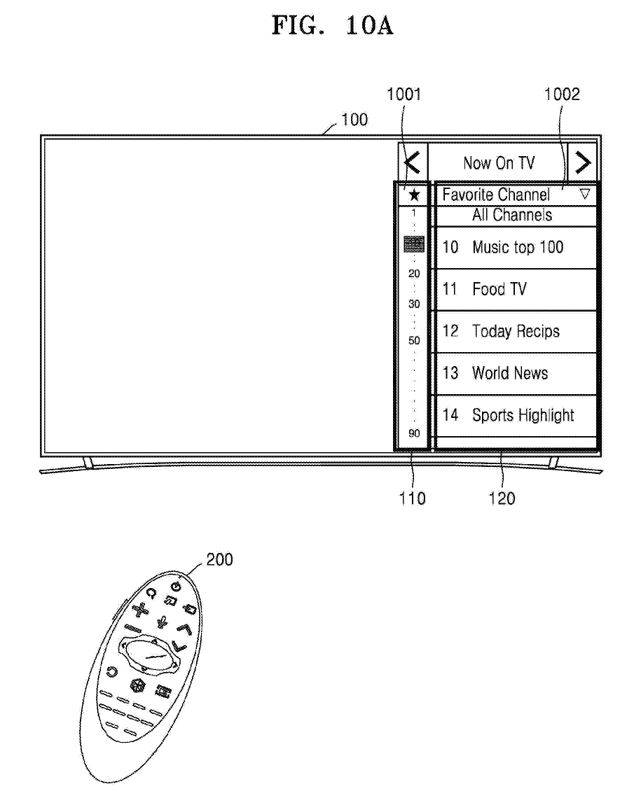

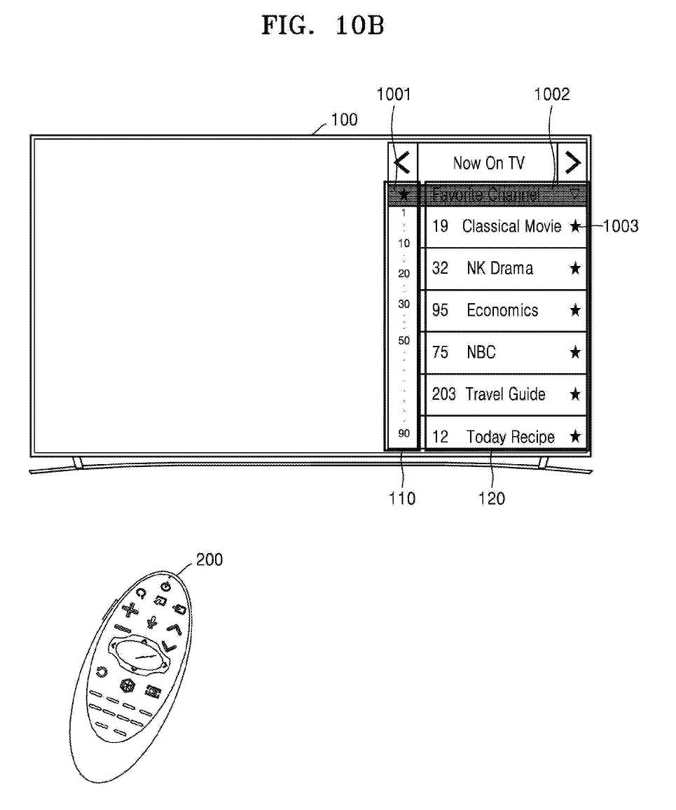

FIGS. 10A and 10B are diagrams illustrating examples of setting favorite channels of the user as index groups on the image display apparatus 100, according to an example embodiment.

The image display apparatus 100 according to an embodiment may set one or more favorite channels of the user as one index group. The image display apparatus 100 may display the index group including the favorite channels of the user on an upper portion of the index group area 110. Alternatively, the image display apparatus 100 may display a tab regarding the favorite channels of the user on an upper portion of the channel list area 120. Accordingly, the image display apparatus 100 may allow the user to easily check the favorite channels while the user is searching for another channel.

Referring to FIG. 10A, the image display apparatus 100 may display an index group 1001 including the favorite channels of the user as a star-shaped icon (⋆) on the index group area 110. Hereinafter, the index group 1001 including the favorite channels of the user will be referred to as a ‘favorite channel group’ for convenience. FIG. 10A illustrates that the favorite channel group 1001 is indicated by the star-shaped icon (⋆), but this is merely an example. The favorite channel group 1001 may be indicated variously according to settings. Since the favorite channel group 1001 is displayed on the upper portion of the index group area 110, the image display apparatus 100 may easily move the highlight to the favorite channel group 1001 while searching for another index group on the index group area 110.

The image display apparatus 100 may display a tab 1002 regarding the favorite channel group 1001 on the upper portion of the channel list area 120.

As illustrated in FIG. 10A, when the favorite channel group 1001 is not selected on the index group area 110, the tab 1002 regarding the favorite channel group 1001 may be folded. However, as illustrated in FIG. 10B, when the favorite channel group 1001 is selected, the tab 1002 regarding the favorite channel group 1001 may be unfolded, and the channels included in the favorite channel group 1001 may be displayed on the channel list area 120.

As described above, once the favorite channel group 1001 is selected, the image display apparatus 100 may display the channels corresponding to the favorite channel group 1001 on the channel list area 120. Alternatively, according to an embodiment, the image display apparatus 100 may move the highlight to the favorite channel group 1001 in order to quickly move to the upper portion of the index group area 110. In this case, when the favorite channel group 1001 is selected and the highlight moves to the tab 1002 regarding the favorite channel group 1001 in response to the user input for selecting the right arrow key, the image display apparatus 100 may display the channels corresponding to the favorite channel group 1001 on the channel list area 120.

The image display apparatus 100 according to an embodiment may display 1003 the channels corresponding to the favorite channel group 1001 distinguishably from other channels. As illustrated in FIG. 10B, the image display apparatus 100 may display 1003 the channels corresponding to the favorite channel group 1001 as star-shaped icons (⋆) identically to the favorite channel group 1001. However, the present disclosure is not limited thereto. As the channels corresponding to the favorite channel group 1001 are displayed 1003 distinguishably from the other channels, the image display apparatus 100 may help the user easily check the channels corresponding to the favorite channel group 1001 on the channel list area 120.

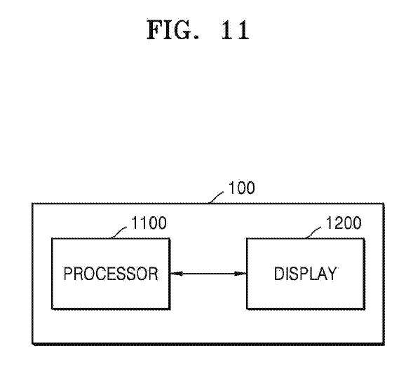

FIG. 11 is a block diagram illustrating an example structure of the image display apparatus 100 according to an example embodiment.

Referring to FIG. 11, the image display apparatus 100 may include a processor (e.g., including processing circuitry) 1100 and a display 1200. However, not all components shown in FIG. 11 are necessary. The image display apparatus 100 may be embodied by more or less components than the components shown in FIG. 11.

Hereinafter, the components will be described in sequence.

The processor 1100 may include various processing circuitry and control the display 1200 to display a channel list area including channels and an index group area including index groups for indexing channels by grouping the channels.

The processor 1100 may flexibly (e.g., dynamically) determine the index groups to be displayed on the index group area, based on information regarding the channels. In this case, the information regarding the channels may indicate the total number of channels. For example, when there are 100 channels in total, the processor 1100 may set 10 channels as one index group, and when there are 1000 channels in total, the processor 1100 may set 100 channels as one index group.

Also, according to channel arrangement criteria, a method of setting index groups may differ. For example, when the channels are arranged based on their numbers, the processor 1100 may set a preset number of channels having adjacent channel numbers as one index group. Alternatively, when the channels are arranged based on their names, the processor 1100 may set channels having the same first letter in their names (e.g., the first letter of the alphabet in an English name, an initial consonant in a Korean syllable, etc.) as one index group.

The processor 1100 controls the display 1200 to display the determined index groups on the index group area.

The processor 1100 may include various circuitry, such as, for example, and without limitation, at least one memory and at least one processor. For example, the memory may generate or delete a program module according to an operation of the processor 1100, and the processor 1100 may process operations of the program module.

The display 1200 may display the index group area and the channel list area including the channels according to the control of the processor 1100. Also, the display 1200 may display, on the index group area, the index groups that are flexibly determined based on the information regarding the channels, according to the control of the processor 1100.

When the display 1200 and a touch pad form a layer structure and thus form a touch screen, the display 1200 may be used also as an input device besides an output device. The display 1200 may include at least one of a liquid crystal display, a thin film transistor-liquid crystal display, an organic light-emitting diode (OLED) display, a flexible display, a 3-dimensional (3D) display, and an electrophoretic display. According to an implementation type of the image display apparatus 100, the image display apparatus 100 may include at least two displays 1200. In this case, the at least two displays 1200 may face each other with a hinge therebetween.

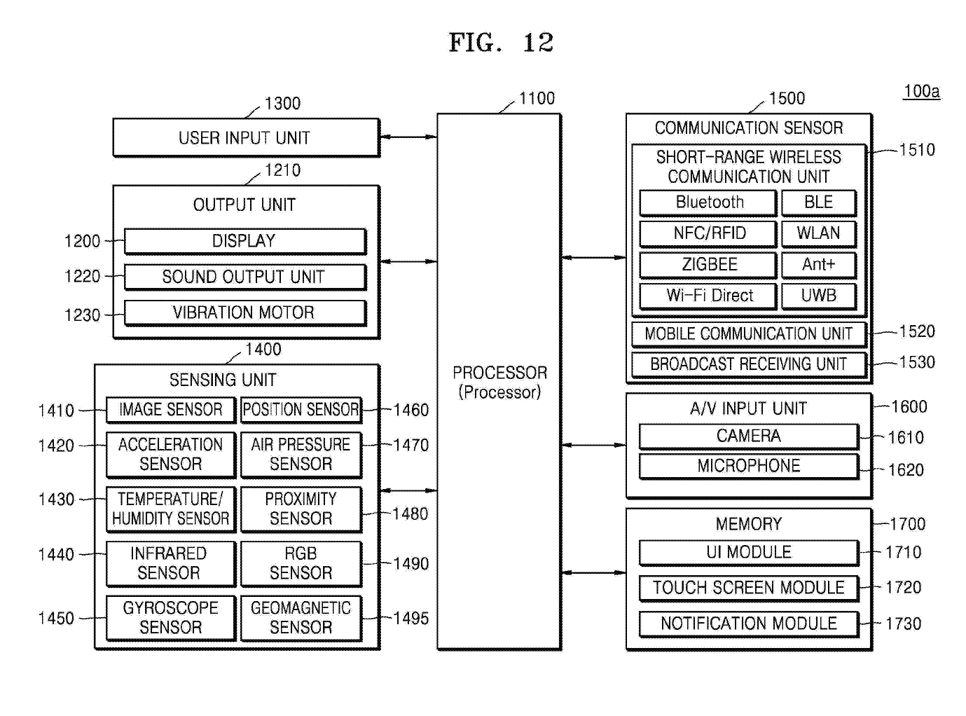

FIG. 12 is a block diagram illustrating an example structure of an image display apparatus 100a according to another example embodiment.

As illustrated in FIG. 12, the image display apparatus 100a may further include a user input unit (e.g., including user input circuitry) 1300, a sensing unit 1400, a communication unit (e.g., including communication circuitry) 1500, an audio/video (A/V) input unit (e.g., including input circuitry) 1600, and a memory 1700 in addition to the processor 1100 and the display 1200.

With regard to the processor 1100 and the display 1200, the descriptions provided with reference to FIG. 11 are omitted.

The user input unit 1300 may include various input circuitry by which the user inputs data so as to control the image display apparatus 100a. For example, the user input unit 1300 may include various input circuitry, such as, for example, and without limitation, a key pad, a dome switch, a touch pad (e.g., a touch capacitive type touch pad, a pressure resistive type touch pad, an infrared beam sensing type touch pad, a surface acoustic wave type touch pad, an integral strain gauge type touch pad, a Piezo effect type touch pad, or the like), a jog wheel, and a jog switch, but the present disclosure is not limited thereto.

The user input unit 1300 may indicate a user input for moving a highlight from the index group area or the channel list area of the image display apparatus 100a. When the user input unit 1300 includes a key pad or a dome switch, the user input for moving the highlight may be an input for clicking or pressing a key corresponding to a certain direction. Alternatively, when the user input unit 1300 includes a touch pad, the user input may be an input for touching a key corresponding to a certain direction. However, the present disclosure is not limited thereto.

Also, the user input unit 1300 may be the component included in the control device 200 or the image display apparatus 100a.

An output unit 1210 may include various output circuitry, such as, for example, and without limitation, a sound output unit 1220 and a vibration motor 1230 in addition to the display 1200.

The sound output unit 1220 may include various circuitry to output audio data received from a communication unit 1500 or stored in the memory 1700. Also, the sound output unit 1220 may output audio signals regarding functions (e.g., a call signal receiving sound, a message receiving sound, an alarm sound, etc.) performed by the image display apparatus 100a. The sound output unit 1220 may include a speaker, a buzzer, or the like.

The vibration motor 1230 may include various circuitry to output a vibration signal. For example, the vibration motor 1230 may output a vibration signal that corresponds to an output of audio data (e.g., a call signal receiving sound, a message receiving sound, or the like) or video data. Also, when a touch is input to the touch screen, the vibration motor 123 may output a vibration signal.

The sensing unit 1400 may include various sensors and detect a state of the image display apparatus 100a or a state around the image display apparatus 100a and may transmit detected information to the processor 1100.

The sensing unit 1400 may include at least one of an image sensor 1410, an acceleration sensor 1420, a temperature/humidity sensor 1430, an infrared sensor 1440, a gyroscope sensor 1450, a position sensor (e.g., a global positioning sensor (GPS)) 1460, an air pressure sensor 1470, a proximity sensor 1480, an RGB sensor (an illuminance sensor) 1490, and a geomagnetic sensor 1495. However, the present disclosure is not limited thereto. Since one of ordinary skill in the art may intuitively infer functions of each sensor from its name, detailed descriptions thereof will be omitted.

The communication unit 1500 may include one or more elements for allowing the image display apparatus 100a to communicate with an external device. For example, the communication unit 1500 may include various communication circuitry, such as, for example, and without limitation, a short-range wireless communication unit 1510, a mobile communication unit 1520, and a broadcast receiving unit 1530.

The short-range wireless communication unit 1510 may include a Bluetooth communication unit, a Bluetooth Low Energy (BLE) communication unit, a Near Field Communication (NFC) unit, a WLAN communication unit, a Zigbee communication unit, an infrared Data Association (IrDA) communication unit, a Wi-Fi Direct (WFD) communication unit, an ultra wideband (UWB) communication unit, an Ant+communication unit, or the like. However, the present disclosure is not limited thereto.

The mobile communication unit 1520 receives/transmits a wireless signal from/to at least one of a broadcast station, an external terminal, and a server via a mobile communication network. The wireless signal may include various types of data according to a voice call signal, a video calling call signal, or reception/transmission of a text message/multimedia message.

The broadcast receiving unit 1530 receives information regarding a broadcast signal and/or a broadcast from the outside through a broadcast channel. The broadcast channel may include a satellite channel and a terrestrial channel. According to an embodiment, the image display apparatus 100a may not include the broadcast receiving unit 1530.

The A/V input unit 1600 may include various A/V input circuitry used to input an audio signal or a video signal and may include a camera 1610, a microphone 1620, and the like.

The camera 1610 may obtain an image frame such as a still image or a moving image through an image sensor in a video call mode or a photographing mode. An image captured by the image sensor may be processed by the processor 1100 or a separate image processor (not shown).

The image frame processed by the camera 1610 may be stored in the memory 1700 or transmitted to the outside through the communication unit 1500. There may be at least two cameras 1610 according to an implementation type of the image display apparatus 100a.

The microphone 1620 may convert a received external audio signal into electrical voice data. For example, the microphone 1620 may receive an audio signal from the external device or a speaker. The microphone 1620 may use various noise removal algorithms for removing noise generated during the receiving of the external audio signal.

The memory 1700 may store programs to process and control the processor 1100 or may store data input to or output from the image display apparatus 100a.

The memory 1700 may include at least one storage medium from among a flash memory-type storage medium, a hard disk-type storage medium, a multimedia card micro-type storage medium, card-type memories (e.g., an SD card, an XD memory, and the like), Random Access Memory (RAM), Static Random Access Memory (SRAM), Read-Only Memory (ROM), Electrically Erasable Programmable Read-Only Memory (EEPROM), Programmable Read-Only Memory (PROM) magnetic memory, a magnetic disc, and an optical disc.

According to an embodiment, the memory 1700 may include a module including at least one instruction for displaying the channel list area including the channels and the index group area including the index groups, flexibly determining the index groups to be displayed on the index group area based on the information regarding the channels, and controlling the display to display the determined index groups on the index group area.

The programs stored in the memory 1700 may be classified into modules, for example, a user interface (UI) module 1710, a touch screen module 1720, and a notification module 1730, according to their functions.

The UI module 1710 may provide a specialized UI or graphical UI (GUI which interoperates with the image display apparatus 100a according to applications. The touch screen module 1720 may detect a user's touch gesture on the touch screen and may transmit information regarding the touch gesture to the processor 1100. The touch screen module 1720 according to some embodiments may recognize and analyze touch codes. The touch screen module 1720 may be configured as separate hardware including a controller.

Various sensors may be arranged in or near the touch screen so as to detect a touch or a proximate touch on the touch screen. An example of the sensor to detect the touch on the touch screen may be a tactile sensor. The tactile sensor detects a contact of a specific object at least as much as a person may detect. The tactile sensor may detect various types of information such as the roughness of a contact surface, the hardness of the contact object, the temperature of a contact point, or the like.

Also, an example of the sensor to detect the touch on the touch screen may be a proximity sensor.

The proximity sensor detects an object comes in contact with a certain contact surface or the existence of an object existing around the certain contact surface by using power of an electromagnetic field or infrared rays without a mechanical contact. Examples of the proximity sensor may be a transmission-type photoelectric sensor, a direct reflection-type photoelectric sensor, a mirror reflection-type photoelectric sensor, a high-frequency oscillation-type proximity sensor, a capacitive type proximity sensor, a magnetic type proximity sensor, an infrared proximity sensor, and the like.

The touch gesture of the user may include a tap gesture, a touch & hold gesture, a double tap gesture, a drag gesture, a panning gesture, a flick gesture, a drag & drop gesture, a swipe gesture, or the like.

The notification module 1730 may generate a signal for notifying the occurrence of events in the image display apparatus 100a. Examples of events occurring in the image display apparatus 100a may be reception of a call signal, reception of a message, a key signal input, a schedule notification, and the like. The notification module 1730 may output a notification signal as a video signal through the display 1200, as an audio signal through the sound output unit 1220, or as a vibration signal through the vibration motor 1230.

The block diagrams showing the image display apparatuses 100 and 100a of FIGS. 11 and 12 are provided for one or more embodiments. Each component shown in the block diagrams may be combined with another component or omitted or an additional component may be added to the components shown in the block diagrams, according to specifications of the image display apparatuses 100 and 100a. That is, according to necessity, two or more components are integrated into one component, or one component may be divided into two or more components. In addition, functions performed by the components are described to explain embodiments, and specific operations or devices do not limit the scope of the present disclosure.

One or more embodiments of the present disclosure may also be embodied as programmed commands to be executed in various computer means, and then may be recorded to a computer-readable recording medium. The computer-readable recording medium may include one or more of the programmed commands, data files, data structures, or the like. The programmed commands recorded on the computer-readable recording medium may be particularly designed or configured for one or more embodiments of the present disclosure or may be well known to one of ordinary skill in the art. Examples of the computer-readable recording medium include magnetic media including hard disks, magnetic tapes, and floppy disks, optical media including CD-ROMs and DVDs, magneto-optical media including optical disks, and a hardware apparatus designed to store and execute the programmed commands in ROM, RAM, a flash memory, and the like. Examples of the programmed commands include not only machine codes generated by a compiler but also codes to be executed in a computer by using an interpreter. The hardware apparatus may be configured to function as one or more software modules so as to perform operations of one or more embodiments of the present disclosure, or vice versa.

It should be understood that the various example embodiments described herein should be considered in a descriptive sense only and not for purposes of limitation. Descriptions of features or aspects within each embodiment should typically be considered as available for other similar features or aspects in other embodiments.

While various example embodiments have been described with reference to the figures, it will be understood by those of ordinary skill in the art that various changes in form and details may be made therein without departing from the spirit and scope as defined by the following claims.

What is claimed is:

1. An image display apparatus comprising:
a display; and
a controller configured to display on the display a channel list area comprising a plurality of channels and an index group area comprising a plurality of index groups indexing the plurality of channels by grouping the plurality of channels, to dynamically determine the plurality of index groups to be displayed on the index group area based on information regarding the plurality of channels, and to control the display to display the plurality of index groups on the index group area.

2. The image display apparatus of claim 1, wherein, the controller is further configured to move a highlight to the selected index group and to display at least one channel corresponding to the selected index group on the channel list area in response to receiving an input selecting one of the plurality of index groups displayed on the index group area.

3. The image display apparatus of claim 2, wherein the controller is further configured to change a number of index groups to which the highlight moves at a time on the index group area.

4. The image display apparatus of claim 1, wherein the controller is further configured to set a number of channels corresponding to each of the plurality of index groups, based on a total number of channels displayed on the channel list area.

5. The image display apparatus of claim 1, wherein the controller is further configured to set a name for each of the plurality of index groups on the channel list area based on channel arrangement criteria.

6. The image display apparatus of claim 5, wherein, when the plurality of channels are arranged on the channel list area based on channel numbers, and the controller is further configured to set a name of each of the plurality of index groups using the channel numbers.

7. The image display apparatus of claim 5, wherein, when the plurality of channels are arranged on the channel list area based on channel names, and the controller is further configured to set a name of each of the plurality of index groups using a character.

8. The image display apparatus of claim 1, wherein the display is configured to display, on an upper portion of the index group area, an index group comprising one or more favorite channels of a user.

9. A method of displaying an image, the method comprising:
displaying a channel list area comprising a plurality of channels and an index group area comprising a plurality of index groups indexing the plurality of channels by grouping the plurality of channels;
dynamically determining the plurality of index groups to be displayed on the index group area based on information regarding the plurality of channels; and
displaying the plurality of index groups on the index group area.

10. The method of claim 9, further comprising:
moving a highlight to the selected index group based on a received input selecting one of the plurality of index groups displayed on the index group area; and
displaying at least one channel corresponding to the selected index group on the channel list area.

11. The method of claim 10, wherein the moving of the highlight comprises changing a number of index groups to which the highlight moves at a time, based on the input.

12. The method of claim 9, wherein the dynamic determining of the plurality of index groups comprises setting a number of channels corresponding to each of the plurality of index groups based on a total number of channels displayed on the channel list area.

13. The method of claim 9, wherein the dynamic determining of the plurality of index groups comprises setting a name of each of the plurality of index groups based on channel arrangement criteria on the channel list area.

14. The method of claim 13, wherein the dynamic determining of the plurality of index groups comprises setting a name of each of the plurality of index groups using the channel numbers, when the plurality of channels are arranged on the channel list area based on channel numbers.

15. The method of claim 13, wherein the dynamic determining of the plurality of index groups comprises, setting a name of each of the plurality of index groups using a character when the plurality of channels are arranged on the channel list area based on channel names.

16. The method of claim 9, wherein the displaying of the plurality of index groups comprises displaying, on an upper portion of the index group area, an index group comprising one or more favorite channels of a user.

17. A non-transitory computer-readable recording medium having recorded thereon a program which, when executed by a processor, causes an image display apparatus to perform the method of claim 9.
